(19) United States
(12) Patent Application Publication
(10) Pub. No.: US 2012/0313376 A1
(43) Pub. Date: Dec. 13, 2012

(54) Method and System for Converting Energy in Flowing Water to Electric Energy

(76) Inventor: Wilson J. Browning, JR., Norfolk, VA (US)

(21) Appl. No.: 13/493,788

(22) Filed: Jun. 11, 2012

Related U.S. Application Data
(60) Provisional application No. 61/520,403, filed on Jun. 9, 2011.

(51) Int. Cl. F03B 13/10

(52) U.S. Cl. 290/54

(57) ABSTRACT

A system and method for converting energy of a moving fluid into electrical power. In one embodiment, the invention is a system comprising: a) a platform fixedly attached to the earth; b) a blade transport mechanism supported by the platform; c) a plurality of blades operably coupled to the blade transport mechanism and oriented to couple energy from the moving fluid; d) a power train operably coupled to the blade transport mechanism; and e) a generator operably coupled to the power train for producing electric power.

### CROSS REFERENCE TO RELATED APPLICATION

This application claims the benefit of U.S. Provisional Patent Application No. 61/520,403, filed Jun. 9, 2011, and entitled Method and System for Converting Energy in Flowing Water to Electric Energy, the entire disclosure of which is incorporated herein by reference.

Harvesting the energy from existing and renewable sources is a critical endeavor if the world is to reduce or eliminate its dependence on fossil fuels. One of the greatest existing and renewable sources of energy is the energy inherent in large flows of water, e.g., river or sea currents, tidal currents, etc. While a variety of submersible systems have been proposed to convert the energy in flowing water to electric energy, none of the proposed systems have been commercially realized owing to mechanical complexities and/or energy-conversion inefficiencies inherent therein.

### SUMMARY OF THE INVENTION

The present method and system can be used for converting the energy in a flowing fluid (such as water) into electric energy. In one embodiment a platform having a top surface and a bottom surface, connected by an edge surface, is aligned with the flow of a fluid, and an assembly of blades harvests the energy in the moving fluid by moving with the fluid. The blades are coupled to a blade transport mechanism which carries the blades and which couples to a power train, which in turn couples to a generator. In one embodiment the blades are attached to a belt mechanism which is slideably located in the platform and moves with the blades. The belt mechanism engages with a power train (which in one embodiment is a series of gears) to rotate a generator to produce electricity. In an alternate embodiment the blades travel on a rail or in a slot (which can be on top of the platform, in the side, or on the bottom) and couple with a power train to rotate the generator. In one embodiment the blades can be made to be variable buoyancy, and as such can be made to be density-neutral to water such that they are effectively weightless in water. This has the advantage of reducing friction and stress within the blade coupling system. In one embodiment air or another gas can be pumped into the blades to make them more buoyant in water. A rail mechanism can be used to support the blades, or a slot can contain a C-clamp which goes over the edge surface. In another embodiment, a slot in the side (edge) of the platform hosts an arm on which the blade is attached. The linear motion of the blades can be converted to rotational motion about a number of axes including a vertical axis or a horizontal axis.

In one embodiment the blades are density neutral to water and the buoyancy is not varied significantly. Arrayed blades, in which sets of blades, spaced horizontally (in the plane of the platform) or vertically (perpendicular to the plane of the platform) can be used to collect additional power from the moving fluid. The arrayed blades can be made to be variable buoyancy and density neutral to water.

In one embodiment magnetic levitation (maglev) technology is used to levitate and/or direct/align the blades and to reduce friction. In one embodiment the maglev system can be used in conjunction with linear generators to provide power as well as levitate.

The platform can be made to be adjustable and can be raised and lowered in the fluid (e.g. from the seabed to the surface) via changes in buoyancy. Directional (e.g. yaw) adjustments can be made through a variety of mechanisms including a bridle and windlass system. An automatic flow sensing system can be used in conjunction with a control system to detect the direction of flow and to cause the system to automatically align with the direction of flow. As such, changes in the direction of tides and currents can be accommodated.

Other objects and advantages of the present invention will become more obvious hereinafter in the specification and drawings.

### BRIEF DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a plan view of a support plate assembly used in the flowing water power generation system in accordance with an embodiment of the system;

FIG. 2 is a cross-sectional view of the conductor plate assembly taken along line 2-2 in FIG. 1;

FIG. 3 is a schematic view of a paddle/blade assembly designed to move along the plate assembly and convert water movement into electricity in accordance with an embodiment of the present invention;

FIG. 4 is a schematic view of a support plate assembly indicating locations thereon where a paddle assembly's paddle flip control can be activated;

FIG. 5 is a schematic view of a support plate assembly supported by multiple post assemblies and configured for adjustment in yaw in accordance with another embodiment of the system;

FIG. 6 is a schematic view of a channeling system disposed upstream and downstream of a support plate assembly in accordance with another embodiment of the system;

FIG. 7 is a schematic view of an adjustable platform;

FIG. 8 is a schematic view of another embodiment of the system;

FIG. 9 is a schematic end cross-sectional view of the embodiment of the system shown in FIG. 8;

FIGS. 10A and 10B are cross-sectional views of a maglev embodiment of the system;

FIGS. 11A and 11B are views of an embodiment including directional adjustment and in particular yaw adjustment;

FIGS. 12A and 12B are schematic views of flows sensors;

FIGS. 13A and 13B are schematic views of horizontal and vertical arrays respectively;

FIG. 14 is a schematic view of a horizontal cross-section of a hollow paddle/blade.

### DETAILED DESCRIPTION

Certain terminology is used herein for convenience only and is not to be taken as a limitation on the embodiments of the present disclosure. In the drawings, the same reference letters are employed for designating the same elements throughout the several figures.

The present invention is a novel method and system for converting the power inherent in moving or flowing fluids (e.g. water, air) to electricity. The method and system described herein can be adapted to a variety of moving fluid environments such as, but not limited to, rivers, littoral regions subjected to tide-based water movement, areas subject to enhanced water movement due to the presence of man-made structures (e.g., bridge trestles), and man-made flow-directing structures (e.g., spillways, pipes, etc.) as well as terrestrial or offshore wind or water currents and tides. Accordingly, the description that follows will focus on the essential features and operating principles of embodiments of the system, but the system and method are not to be considered limited by size constraints or construction specifics that are subject to change for a particular application.

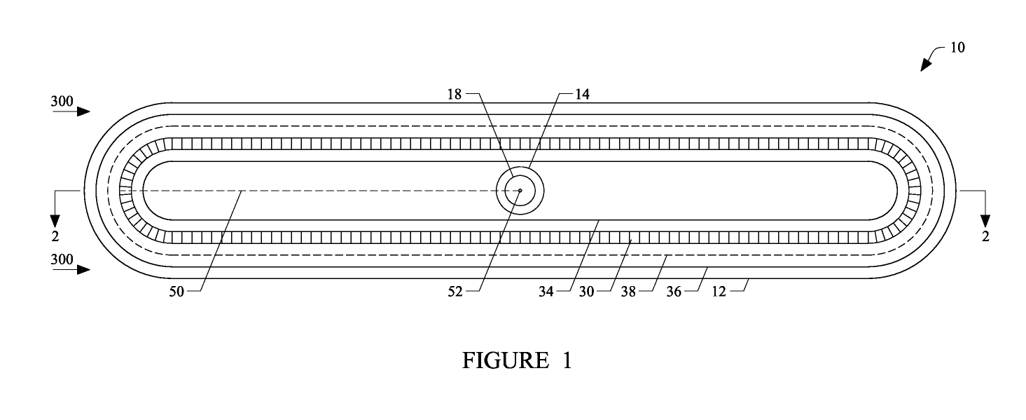

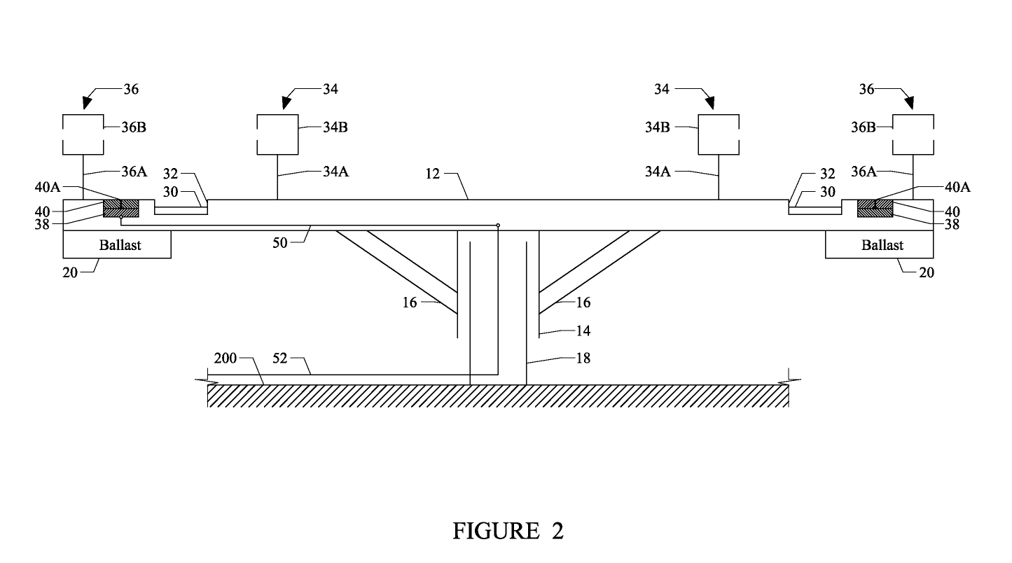

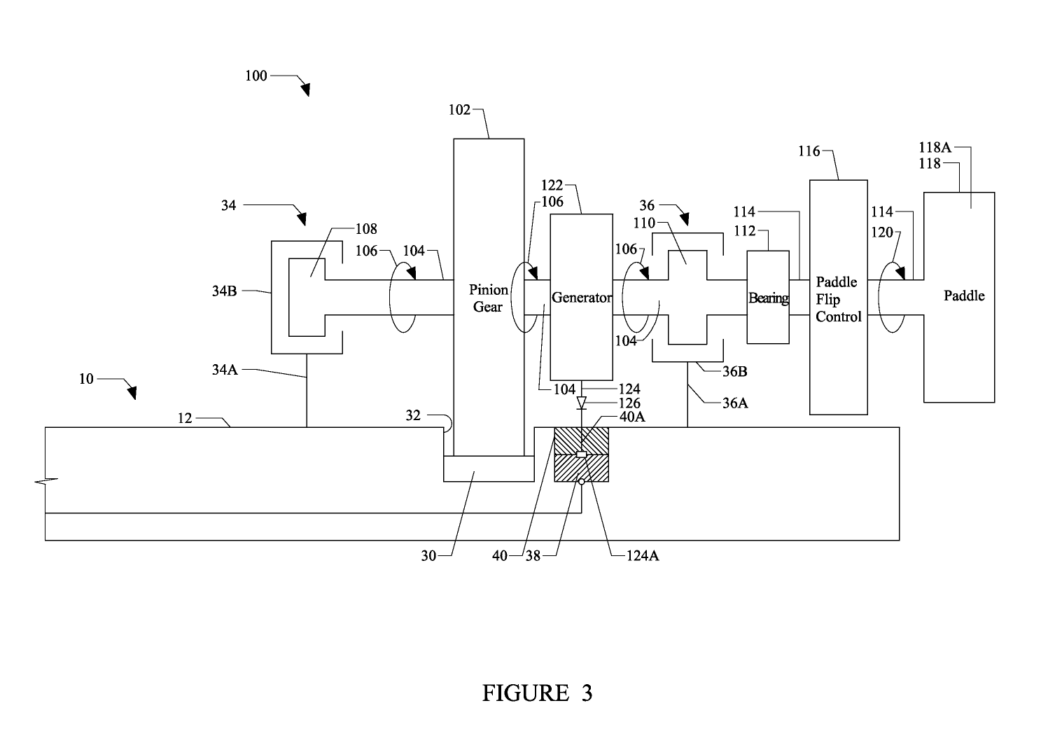

For clarity of illustration, FIGS. 1-3 illustrate the primary sub-assemblies of an embodiment of the flowing fluid power generation system of the present invention. In FIGS. 1 and 2, a support plate assembly in accordance with an embodiment of the present invention is shown and is referenced generally by numeral 10. FIG. 3 illustrates a paddle/blade assembly 100 in accordance with an embodiment of the present invention that cooperates with fluid movement and support plate assembly 10 to generate electricity. A number of such paddle/blade assemblies 100 will be used with one support plate assembly 10 as will be described further below. For generation of electric energy, it is assumed that both support plate assembly 10 and each provided paddle assembly 100 are submerged within a flow of moving fluid (e.g. water, not shown).

Referring first to FIGS. 1 and 2, support plate assembly 10 includes a main plate 12 and a plate support post 14 coupled thereto at a central portion of main plate 12 by, for example, use of supports 16. In the illustrated embodiment, plate support post 14 is hollow and fits coaxially over a lower support post 18 affixed to a ground location (e.g., a sea floor 200). Lower support post 18 can also be hollow for reasons that will be explained later below. In general, the combination of plate 12/post 14 is movable up/down relative to (and on) post 18 so that plate 12 can be positioned at a desired depth in its water environment. To facilitate such movement and maintenance of plate 12 at a desired depth, permanent and/or adjustable ballast elements 20 can be coupled to plate 12. The number, size, and type of ballast elements 20, and control thereof, are not limitations of the present invention. Since plate 12 in combination with ballast 20 can be the same density as water and can move up and down as needed (e.g., above the water's surface for maintenance), lower support post 18 will only receive stresses from horizontal forces or yaw. Such forces can be readily handled by an anchoring system (not shown) for post 18.

Main plate 12 can be solid but can also have holes therein (not shown) to allow water to flow therethrough without departing from the scope of the present invention. The hole pattern can have the goals of reducing the amount of material needed for plate 12, lowering the weight of plate 12, directing flowing water moving past plate 12, or combining attributes of these goals. The material used for plate 12 should generally be light in weight, strong, electrically insulating, and non-corrosive in water. Plate 12 can also be constructed to have the same density as water in order to facilitate the raising/lowering thereof using ballast 20. The various parts can be made using materials that have the same density as water thereby making them very light in an underwater environment. Further, the parts could be partially or fully hollow to facilitate the density attribute. Material choices for plate 12 can include plastics, composites, etc. Similar materials can be used for plate support post 14 and support 16. Lower support post 18 could also make use of the same materials but could also be made from concrete for permanent installations.

Support plate assembly 10 includes structural elements that allow a number of paddle/blade assemblies 100 to “walk” around a defined “oval” shape on plate 12 where such movement is propelled by flowing fluid. As used herein, the term “oval” includes any shape having opposing longer sides/legs joined by opposing shorter sides/legs with some type of curvature or other connecting shape formed in the shorter sides/legs. For example, an oval can be a racetrack-type of shape, a rectangle with curved corners, two same-length parallel lines connected to one another at their aligned ends by semicircles or other arc shapes, a dog-bone shape, etc.

Support plate assembly 10 is positioned in its fluid environment such that the long straight sides/legs of the oval shape are aligned with the direction of the flowing fluid. For example, the direction of the flowing fluid in the illustrated embodiment is indicated by arrows 300. Disposed along the oval shape on plate 12 are a gear track 30 in a groove 32 formed in plate 12, on elevated rail track 34 (shown as a single solid line in FIG. 1) inside of and concentric with gear track 30, an elevated rail track 36 (shown as a single solid line in FIG. 1) outside of and concentric with gear track 30, and an electrical conductor track 38 (shown as a dashed line in FIG. 1) embedded within the electrically insulting material of plate 12.

Gear track 30 is analogous to a rack gear laid out in a continuous oval. The radius of curvature of the oval and configuration of the gear teeth (of gear track 30) at the oval's curves can be designed to satisfy the needs of a particular installation without departing from the scope of the present invention. The placement of gear track 30 in groove 32 provides guidance for each paddle assembly's pinion gear as will be explained later below. Gear track 30 and the walls of groove 32 can be constructed of or coated with low-friction materials to minimize friction losses with each paddle assembly's pinion gear.

Elevated rail tracks 34 and 36 provide support and guidance for each paddle assembly 100 propelled around support plate assembly 10 by flawing fluid. While two such elevated rail tracks are shown in the illustrated embodiment, it is to be understood that additional (or fewer) rail tracks could be used without departing from the scope of the present invention. It is to be further understood that other types of paddle assembly support/guidance structures could be employed on and/or in plate 12 without departing from the scope of the present invention.

As shown in FIG. 2, each elevated rail track 34 and 36 includes an elevating structure(s) 34A and 36A, respectively, fixedly mounted on plate 12. For example, elevating structures 34A and 36A could be realized by a series of posts distributed about the oval shape defined on plate 12. Mounted atop elevating structures 34A and 36A are housings 34B and 36B, respectively, each of which runs continuously around plate 12 in the defined oval shape as best seen in FIG. 1. As will be explained further below; housings 34B and 36B provide support and guidance for wheels mounted on a rotating axle of each paddle assembly 100. Materials used for the interior wheel-bearing surfaces of housings 34B and 36B can be constructed of or coated with low-friction materials.

As mentioned above, electrical conductor track 38 is embedded within the electrically insulating material of plate 12. However, an electrical tap (to be discussed further below) of each paddle/blade assembly 100 needs to make electrical contact with conductor track 38 as each paddle assembly 100 walks around the oval shape defined on support plate assembly 10. That is, the electrical tap of each paddle/blade assembly 100 transfers the electric power generated by each paddle assembly 100 to conductor track 38. A surface of conductor track 38 (e.g., a top surface as illustrated) is separated from the water environment (in which assembly 10 is submerged) by a self-sealing membrane assembly 40. Membrane assembly 40 incorporates a slit 40A therethrough that is continuous over conductor track 38. In this way, the electrical tap from each paddle assembly 100 can pass through membrane 40 to contact conductor track 38 as a paddle assembly 100 walks around the oval shape defined on support plate assembly 10. Membrane 40 can be made from a variety of pliable, self-sealing materials to keep conductor track 38 dry as the electrical tap moves through slit 40A.

The electric energy generated by each paddle/blade assembly 100 is transferred to conductor track 38 as described above. One (or more) radial conductor taps (illustrated by dashed line 50 in FIG. 1) transfer the electric energy from conductor track 38 to the hollow regions of posts 14/18 where an underwater electrical conductor 52 can carry the electric energy to its next destination (e.g., energy storage facility, energy distribution facility, etc.).

One paddle/blade assembly 100 in accordance with an embodiment of the present invention will now be described with reference to FIG. 3 where the portions of support plate assembly 10 interfacing with paddle assembly 100 are also illustrated. As mentioned above, a number of paddle/blade assemblies 100 will be used to convert the energy in flowing water to electric energy. In FIG. 3, the flow of fluid is assumed to be into the surface of the paper and perpendicular thereto. All such paddle/blade assemblies 100 are mechanically linked to one another in succession for simultaneous movement around the oval shape defined by support plate 10. Methods and systems used to link paddle/blade assemblies 100 are not limitations of the present invention.

Paddle/blade assembly 100 includes a pinion gear 102 coupled to an axle 104 such that rotation of pinion gear 102 causes simultaneous rotation of axle 104 as indicated by rotational arrows 106. Coupled to axle 104 on one side of pinion gear 102 is a wheel 108 that resides in housing 34B of elevated rail track 34. Coupled to axle 104 on the other side of pinion gear 102 is a wheel 110 that resides in housing 36B of elevated rail track 36. Wheels 108 and 110 can rotate with axle 104 or independently thereof.

Axle 104 extends away from wheel 110 to a bearing 112 that couples axle 104 to a paddle axle 114. Bearing 112 is configured to allow axles 104 and 114 to rotate independently. Axle 114 has a paddle/blade flip control 116 coupled thereto and has a paddle/blade 118 fixedly coupled to the outboard end thereof such that any rotation of paddle axle 114 causes commensurate rotation of paddle/blade 118. Paddle/blade 118 is any structure having at least one flat and broad face 118A that develops a substantial force over face 118A when face 118A is perpendicular (as shown) to an oncoming flow of water. Paddle/blade 118 is also a thin structure such that minimal forces act thereon when face 118A is aligned parallel to an oncoming flow of water. That is, when paddle/blade 118 is rotated 90° to its illustrated orientation, minimal force from the flow of fluid acts on paddle/blade 118.

Paddle/blade flip control 116 controls the rotational orientation of paddle/blade 118 based upon the direction of the flowing water and the position of paddle assembly 100 on support plate assembly 10. In general, paddle/blade flip control 116 positions paddle/blade 118 such that face 118A is (i) perpendicular (as shown) to an oncoming flow of fluid along one long side of the oval shape defined on support plate assembly 10, or (ii) parallel to an oncoming flow of fluid along the remaining portions of the oval shape defined on support plate assembly 10. That is, paddle/blade flip control 116 causes paddle/blade axle 114 to rotate 90° (as indicated by rotational arrow 120) when paddle/blade 118 must be parallel to the flowing water, and also causes axle 114 to rotate paddle/blade 118 when face 118A must be perpendicular to the flowing water.

Paddle/blade flip control 116 can be realized in a variety of ways without departing from the scope of the present invention. For example, paddle/blade flip control 116 could be a mechanical feature (e.g., gear) provided on paddle/blade axle 114 that is designed to cooperate with another mechanical feature (e.g., gear) positioned at specified locations on support plate assembly 10. Paddle/blade flip control 116 could also be realized by magnetic or electromagnetic features coupled to or incorporated in paddle/blade axle 114 where such features are activated by cooperating features positioned at specified locations on support plate assembly 10.

In use, with paddle/blade assembly 100 positioned as shown with an oncoming flow of fluid moving into the paper, forces on paddle/blade 118 cause paddle/blade assembly 100 to walk along support plate assembly 10 as pinion gear 102 rotates and cooperates with gear track 30. At the same time, wheels 108 and 110 travel in the oval shape defined by housings 34B and 36B, respectively.

Each paddle/blade assembly 100 also includes a generator 122 coupled to axle 104 such that the axle's rotation (owing to the rotation of pinion gear 102) is converted to electricity. While the speed of the flowing fluid, and in particular with respect to water, may be slow (e.g., 2-3 knots for a tidal current), the hydrodynamic force thereof is substantial. Thus, the flow of water will typically produce slow-speed but high-torque rotation of gear 102/axle 104. Accordingly, generator 122 is configured to convert such slow-speed, high-torque rotation of axle 104 to electric energy. The electric energy produced by generator 122 is transferred to conductor track 38 using a conducting “pin” 124 that extends through membrane slit 40A where the “foot” 124A of pin 124 contacts track 38. Pin 124/foot 124A can be realized by a variety of constructions without departing from the scope of the present invention. Current blocking element(s) 126 (e.g., a diode) electrically prevent the back flow of electric current into generator 122 as paddle assembly 100 moves around support plate assembly 10. Note that electric energy transfer from generator 122 to track 38 could also be accomplished in other ways such as through the use of a commutator as would be understood in the art.

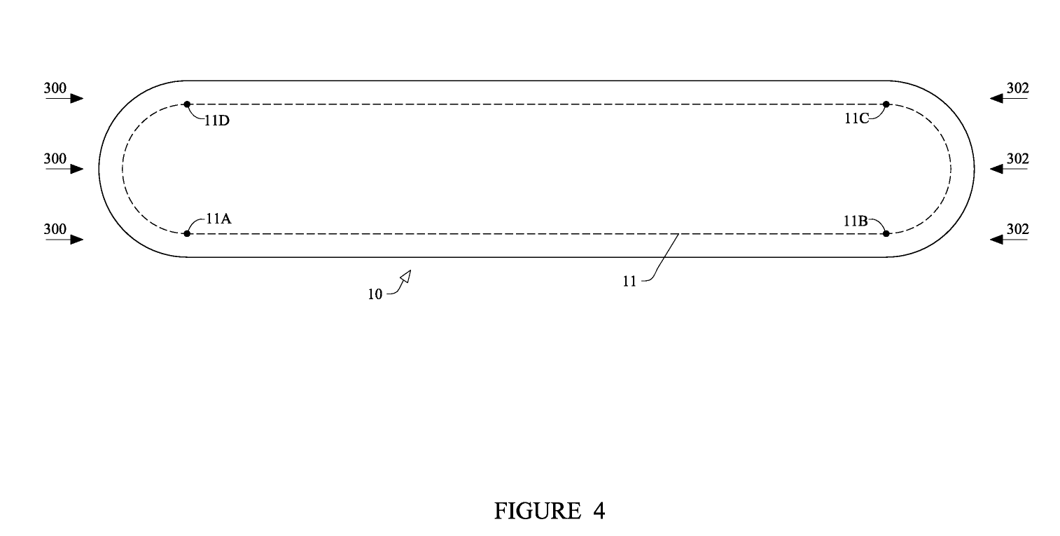

As mentioned above, each paddle/blade assembly's paddle/blade 118 is positioned (by its paddle/blade flip control 116) to have its face 118A either perpendicular or parallel to an oncoming flow of fluid. Such positioning is governed by the direction of the flowing fluid and the position of the paddle/blade assembly on the oval shape defined on support plate assembly 10. Two flow direction scenarios illustrating this concept are presented schematically in FIG. 4 where the oval shape defined by the various track elements described above is referenced on support plate assembly 10 simply by a dashed line 11. For clarity of illustration, no paddle/blade assemblies 100 are shown in FIG. 4. Two possible water flow directions are indicated by arrows 300 and 302. As described above, support plate assembly 10 is positioned such that the two long sides of oval 11 are substantially aligned with flows 300 and 302. By way of example, flows 300 and 302 could represent incoming and outgoing, respectively, tidal flows. Four locations 11A-11D indicate locations on oval 11 where the above-described paddle/blade flip control 116 of each paddle/blade assembly 100 will be engaged/activated. When flowing water is in the direction of flow 300, each paddle/blade assembly has its paddle/blade rotated to be perpendicular to flow 300 at location 11A. In this way, each paddle/blade assembly's paddle/blade is positioned to maximize the hydrodynamic force acting thereon. When each paddle/blade assembly reaches location 11B, the corresponding paddle/blade is rotated to be parallel to flow 300 to thereby minimize the hydrodynamic force acting thereon. The parallel position of the paddle/blade is maintained along oval 11 from location 11B, past locations 11C and 11D, and until location 11A where it is once again rotated to be perpendicular to flow 300. When the fluid is flowing in the direction of flow 302, each paddle assembly has its paddle/blade rotated to be perpendicular to flow 302 at location 11C. Then, when each paddle/blade assembly reaches location 11D, the corresponding paddle/blade is rotated to be parallel to flow 302. The parallel position of the paddle/blade is maintained along oval 11 from location 11D, past locations 11A and 11B, and until location 11C where it is once again rotated to be perpendicular to flow 302.

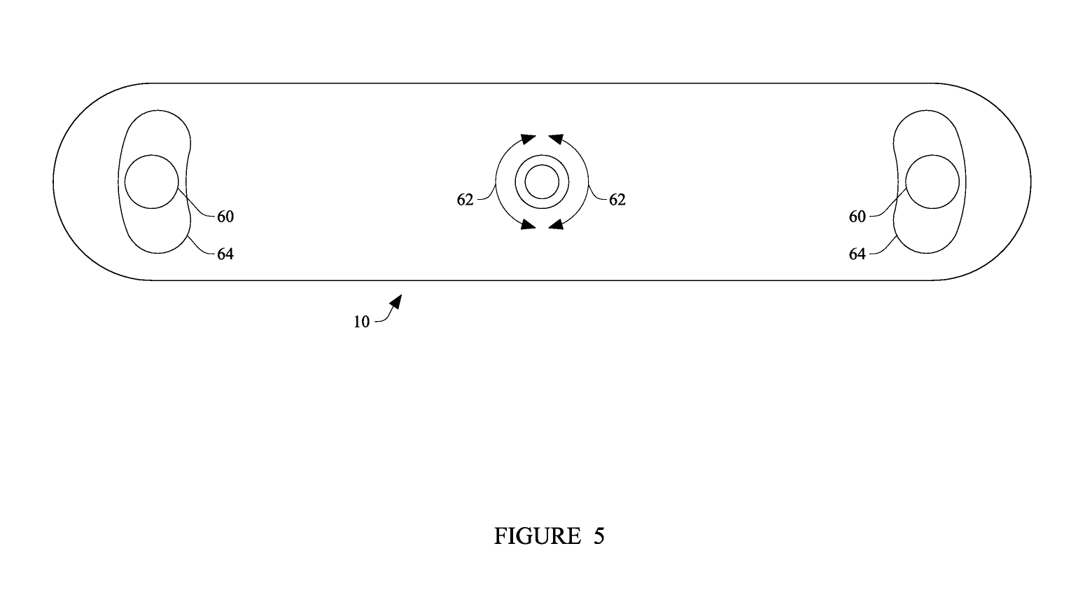

Depending on the size of the support plate assembly, in some instances it is advantageous to support the plate (e.g., plate 12) with more than the central post assembly (e.g., posts 14/18). Further, it may be desirable to provide for directional adjustment (e.g. yaw) of the support plate assembly so that the straight portions of the oval shaped track elements can be aligned with the direction of an oncoming flow of fluid. Accordingly, FIG. 5 illustrates a schematic plan view of support plate to assembly 10 having additional support post assemblies 60 coupled thereto. Assuming a system (not shown) is provided to adjust support plate assembly 10 in yaw (as indicated by two headed arrows 62), support plate assembly 10 can incorporate curved slots 64 to facilitate yaw motion 62. Note that the amount of curvature in slots 64 has been exaggerated for illustration purposes.

In order to keep friction at a minimum in the system, a number of low friction materials can be used including low friction polymers such as polytetrafluoroethylene (PTFE, also known as Teflon), Delrin, Vesconite (which performs well even in water), and Near Frictionless Carbon (NFC). These materials can be used to form or coat the gears in the power train, can be coated onto the platform or even form some or all of the platform itself and thus provide low friction guidance/support for the blades in a slot or C-clamp configuration or for a rail system on which the blades travel. In embodiments where a belt are used, high-strength synthetic fibers such as Kevlar can be incorporated into the belt or can be used to form the belt in its entirety. Other low friction materials can be incorporated into the components of the system to minimize friction while maintaining strength.

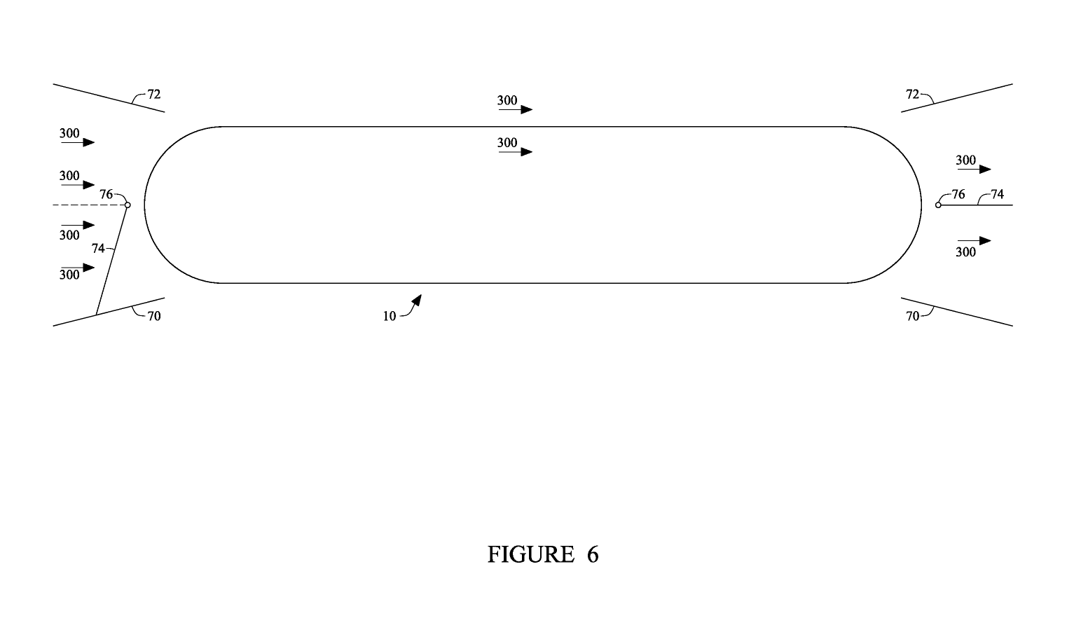

The present invention can also be used in conjunction with a fluid channeling system disposed both upstream and downstream the support plate assembly with its paddle assemblies described above. In general, the channeling system directs an oncoming fluid (e.g. water) flow along one long side of the support plate assembly where paddles/blades will be perpendicular thereto while simultaneously impeding the water flow on the other long side of the support plate assembly where paddles/blades will be parallel to the oncoming water flow. An example of such a channeling system is illustrated schematically in FIG. 6. Upstream and downstream of support plate assembly 10 are fixed walls 70 and 72 extending away from assembly 10 to define V-shaped channels starting at either end of assembly 10 as shown. Positioned in each such V-channel is a gate 74 coupled to a pivot 76. The operation and function of gates 74 will be explained for flow 300 flowing in the direction indicated. Gates 74 are configured such that when an oncoming water flow (e.g., flow 300) impinges on a gate 74 upstream of assembly 10, gate 74 pivots at 76 to direct flow 300 towards one long side of assembly 10 while impeding flow 300 along the other long side of assembly 10. At the same time, gate 74 at the downstream side of support plate assembly 10 is positioned centrally between channel walls 70/72 to allow flow 300 to move therethrough. The situation would be reversed if the water flow came from the opposite direction.

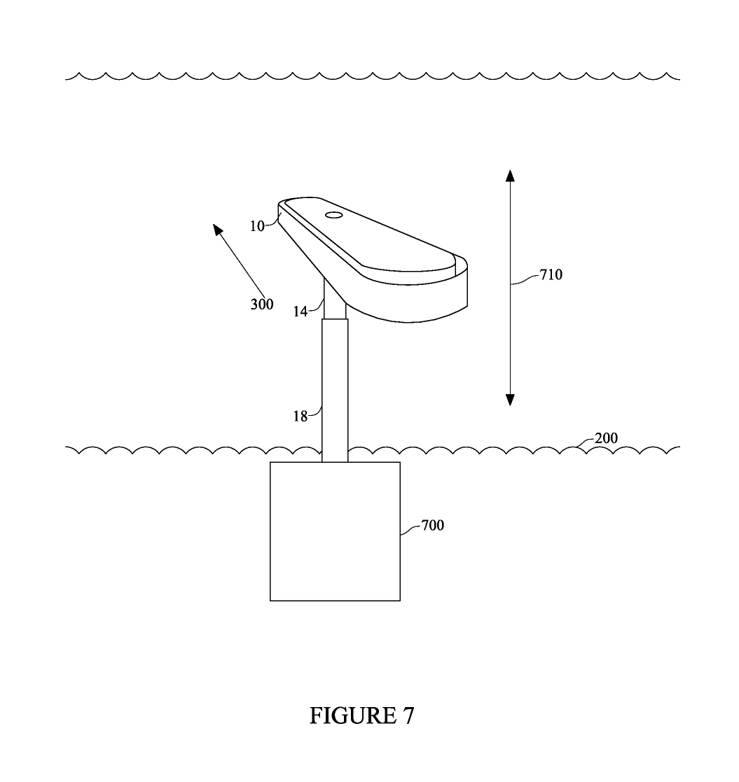

Referring to FIG. 7, an embodiment of the system in which support plate assembly 10 is supported by a plate support post 14 moveably engaged in a post 18 is illustrated. In one embodiment post 18 is embedded or otherwise attached to an anchor element 700 (e.g. concrete) within sea floor 200. In one embodiment the system (including paddle/blade assemblies not shown in FIG. 7) can be raised and lowered along vertical axis 710. This can be accomplished through the use of ballast elements 20 or through the use of variable buoyancy components. In one embodiment support plate assembly 10 has variable buoyancy elements (e.g. hulls or chambers) which can be filled with gas (e.g. air, nitrogen, helium) or liquid (e.g. water) to vary the buoyancy of the entire platform. In one embodiment the system is operated underwater (e.g. in a river, estuary, or other area with substantial tides or underwater currents) and support plate assembly 10 can be raised to the surface for servicing, repair, inspection, or other activities. The system can also be sunk to allow for complete clearance, or can be placed at an optimum height for collection of tidal power. The variable buoyancy elements can be pumped out or filled with an appropriate density gas or liquid to obtain the desired buoyancy. In one embodiment the system can be made to be water-density neutral and as such will essentially float beneath the surface of the water, thus reducing stress on plate support post 14 and post 18 or on whatever alternate support/anchoring structure is utilized.

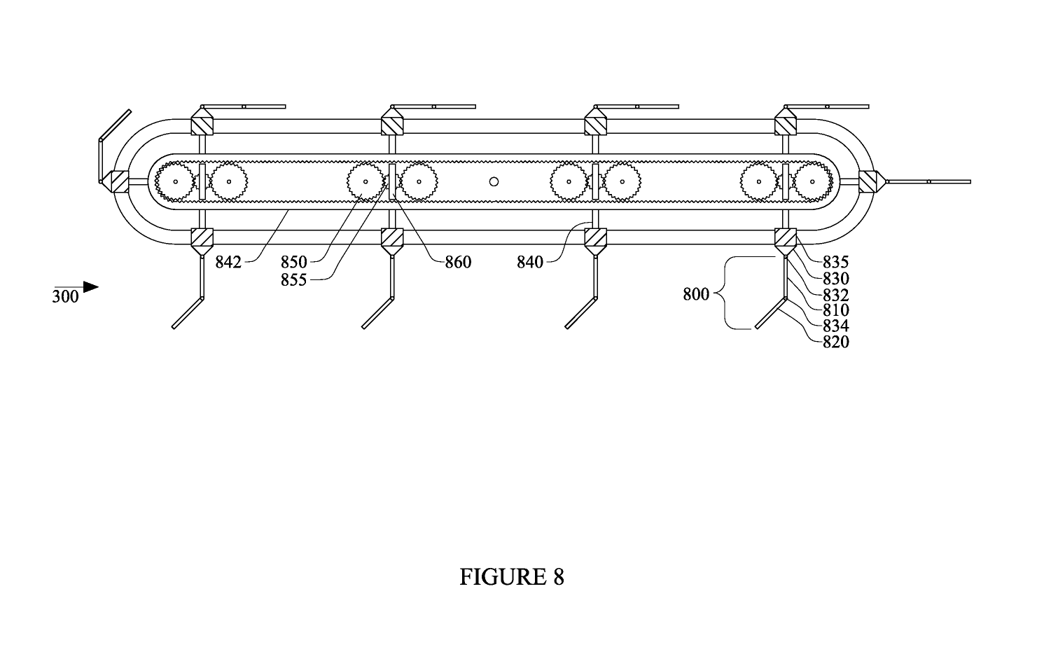

Referring to FIG. 8, an embodiment of the system is shown which is based on the use of a belt coupled to a power train which converts the linear motion of the belt to rotational motion which drives a generator to produce electricity. In FIG. 8 the folding paddle/blade assembly 800 is comprised of outer blade 820 coupled to inner blade 810 via a first hinge 834. The folding paddle/blade assembly 800 connects to an attachment assembly 830 via a second hinge 832. In one embodiment an attachment block 835 connects attachment assembly 830 to arm 840. In another embodiment arm 840 connects directly to attachment assembly 830. Arm 840 connects to belt 842 which, in one embodiment, has teeth which engage with a series of belt contacting gears 850. Belt contacting gear 850 interfaces with generator gear 855 to drive a generator. The belt. contacting gear 850 in conjunction with generator gear 855 serves as a power train, although a number of power trains can be used, all based on mechanical mechanisms for the transfer of power and to obtain appropriate rotational speeds for the optimum generation of electricity. As can be understood from FIG. 8, fluid flow 300 results in folding paddle/blade assembly 800 opening when moving with fluid flow 300, and closing (folding over) when traveling against fluid flow 300. In one embodiment activated stops can be used in first hinge 800 to place outer blade 820 at less than a 90° angle to the direction of fluid flow 300. For example, an electrically activated solenoid can be used in first hinge 800 to maintain a shape on folding paddle/blade assembly 800 that maximizes the collection of energy from the moving fluid, while allowing the folding paddle/blade assembly 800 to flatten completely as it travels against the current.

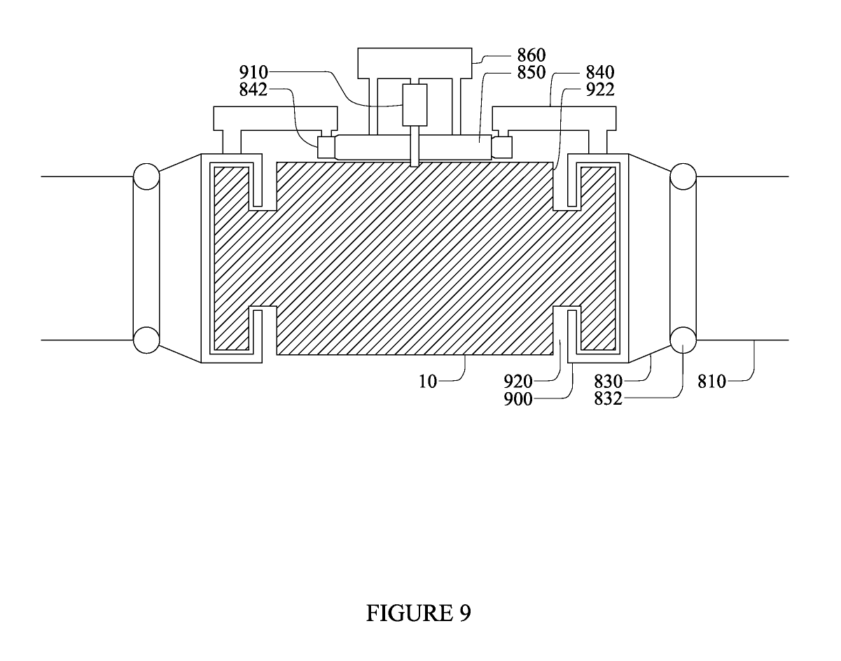

Referring to FIG. 9, a cross-sectional end view of the embodiment of FIG. 8 is shown in which support plate assembly 10 contains a bottom slot 920 and a corresponding upper slot 922. The slots house a C-clamp assembly 900 which attaches to both arm 840 and attachment assembly 830 (attaching to folding paddle/blade assembly 800 via second hinge 832). In this embodiment arm 840 is connected to belt, 842, which is in turn engaged with belt contacting gear 850. As previously discussed, belt contacting gear 850 is engaged with generator gear 855 (not shown) which turns generator 910. In this embodiment generator assembly 860, in the form of an arch, houses and holds generator 910. In this embodiment the linear motion of belt 842 (created by the capture of the flowing fluid energy by folding paddle/blade assemblies 800) is converted into rotational motion about an axis which is perpendicular to support plate assembly 10.

It should be understood that belts, rails, and slots, all of which can be placed either on the top, edges, or bottom of the platform, can be used to both guide the paddles/blades, as well as for coupling the power from the linear motion of the paddles/blades to a power train (which is typically comprised of sets of gears, although other mechanical mechanisms including belts, clutches, drive shafts can be used). The belts, rails and slots which guide the paddles/blades can all be considered to be blade transport mechanisms, although other blade transport mechanisms are possible.

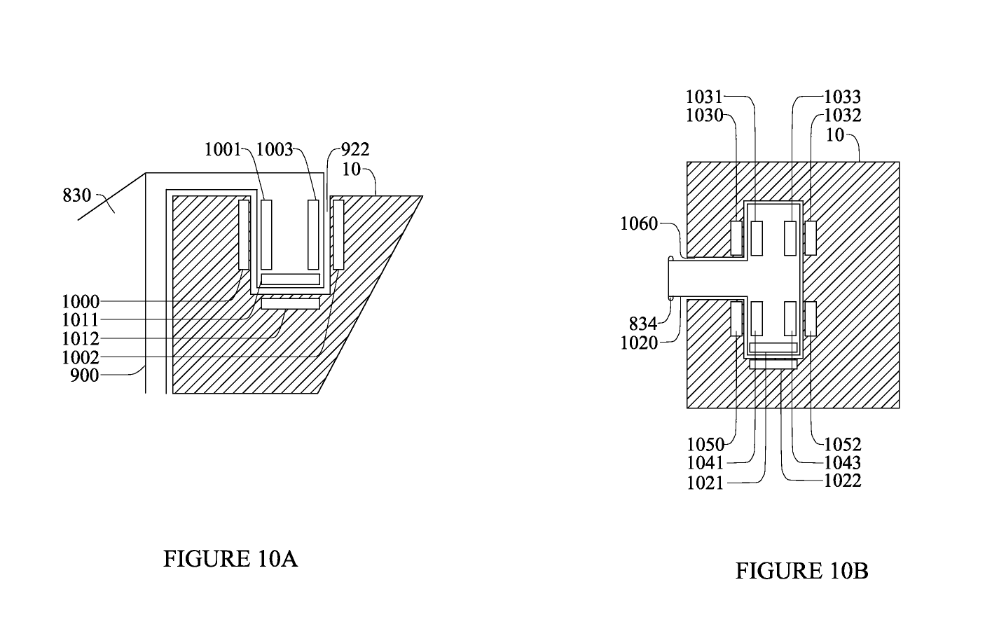

Referring to FIGS. 10A and 10B embodiments utilizing magnetic levitation (maglev) are shown. FIG. 10 illustrates an embodiment housing C-clamp 900 (bottom portion not illustrated) or a partial C-clamp (having only an upper engaging portion). In this embodiment upper slot 922 houses clamp magnets 1001, 1003 and 1011. Clamp magnets 1001, 1003 and 1011 arc of a polarity opposite to their corresponding platform magnets 1000, 1003 and 1112 respectively. As will be understood by one of skill in the art, the opposing magnets 1011 and 1012 provide levitation and opposing magnets 1000-1001 and 1002-1003 provide positioning. This allows for near frictionless motion of C-clamp 900. Other configurations of magnets can be utilized to reduce or nearly eliminate friction.

FIG. 10B illustrates a maglev configuration based on an embedded slot 1060 with a corresponding embedded arm 1020. Embedded arm 1020 houses magnets 1031, 1033, 1041 and 1043 for positioning/alignment through interaction with platform magnets 1030, 1032, 1050 and 1052 respectively. Embedded arm magnet 1022 provides levitation of embedded arm 1020 through interaction with platform magnet 1021.

In one embodiment permanent magnets are used for some or all of the magnets illustrated in FIGS. 10A and 10B. Materials such as Neodymium Iron Boron (NdFeB) can be used, and the magnets can be divided into subassemblies. In one embodiment a Halbach array of permanent magnets that augments the magnetic field on one side of the array while cancelling the field to near zero on the other side is used. In an alternate embodiment some or all of the magnets of FIGS. 10A and 10B are electromagnets, in which a current passed through a coil of wire creates a magnetic field.

As will be discussed, folding paddle/blade assemblies 800 can be made to be variable buoyancy or water-density neutral, thus reducing their effective weight and therefore reducing the effective load and friction between C-clamp 900 and its corresponding slot, or between embedded arm 1020 and embedded slot 1060. In this embodiment the magnets used to obtain levitation (and for alignment) can be of lesser or very modest strength as compared to magnets which must bear the full weight of the folding paddle/blade assemblies 800.

In another embodiment, platform magnets 1000, 1002 and 1030, 1032, 1050 and 1052 are replaced with coils and instead of providing positioning/alignment are used to produce electricity. In this embodiment, the sidewall maglev configuration becomes the generator, thus eliminating the need for a power train and rotating generator. Other configurations of magnets and coils, know to those of skill in the art, can be used to combine the properties of magnetic levitation systems with generators and can result in the elimination of the separate generator. In other embodiments, generator 122 is used in conjunction with the maglev subsystem to provide powered levitation.

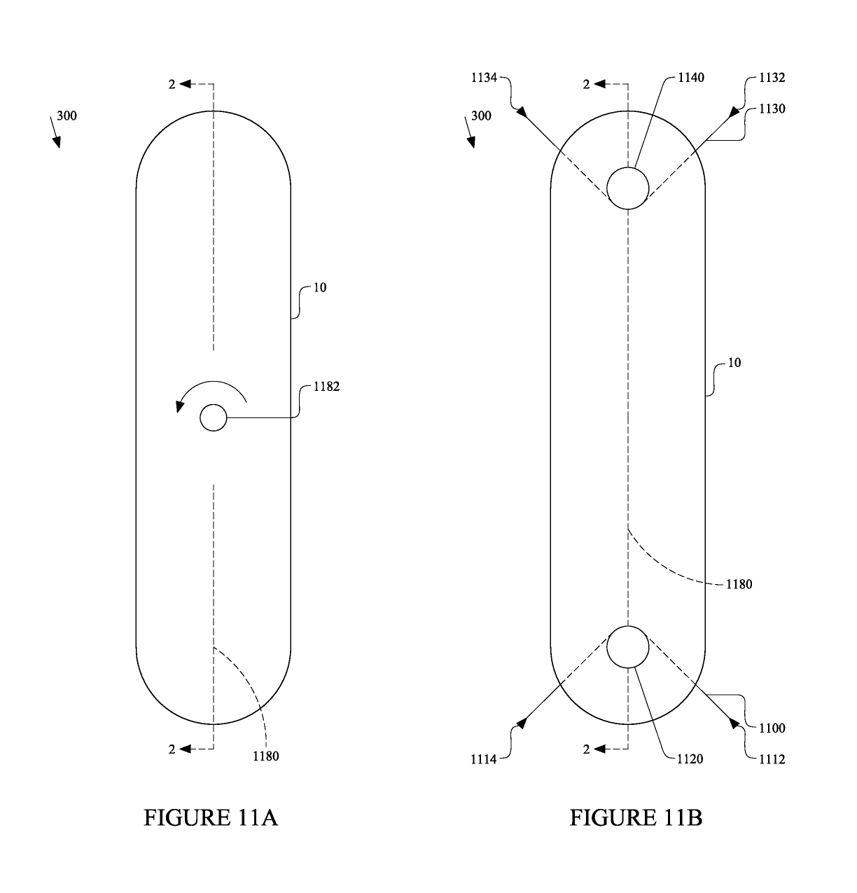

FIGS. 11A and 11B are views of an embodiment including directional adjustment and in particular yaw adjustment. FIG. 11A illustrates an embodiment in which yaw of support plate assembly 10 is adjusted through rotation about a vertical axis 1182, in order to align horizontal platform axis 1180 with flowing fluid direction 300. FIG. 11B illustrates a bridle and windlass system in which a stern windlass 1120 and bow windlass 1140 are used in conjunction with stern adjustment cable 1100 and bow adjustment cable 1130 (anchored via stern anchor points and bow anchor points 1132 and 1134 respectively) to adjust the yaw of support plate assembly 10. An advantage of the embodiment of FIG. 11B is that both the bow and stern can be adjusted, allowing for better alignment of the system (e.g. horizontal platform axis 1180) with flowing fluid direction 300. Variations on the bridle and windlass system, known to those of skill in the art, can be used to provide yaw alignment of the system.

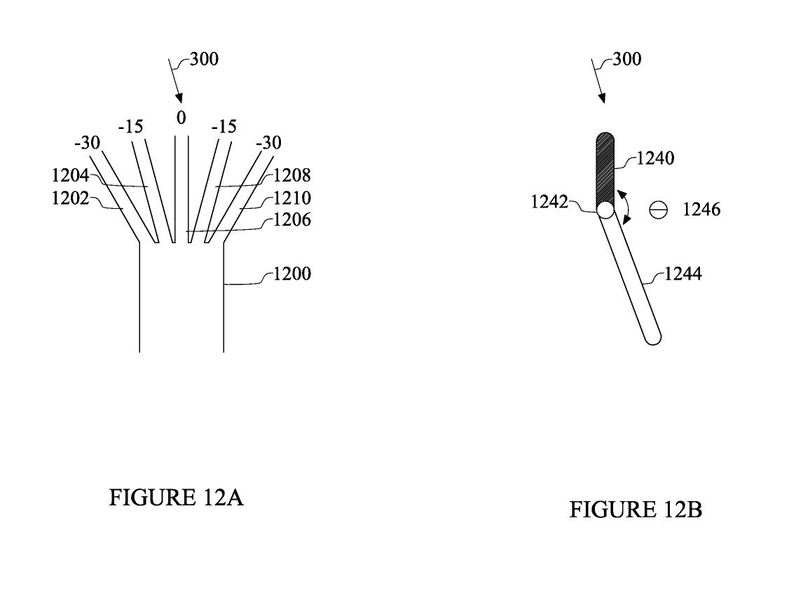

FIG. 12A illustrates a flow direction monitoring system comprised of a flow direction sensor 1200 having a series of directional flow channels 1202, 1204, 1206, 1208 and 1210. By sensing the amount of fluid passing through the flow channels, flowing fluid direction 300 can be determined. A number of readily available flow sensors, including mechanical, electromechanical, and/or optical sensors can be used in the flow direction sensor. An alternate flow direction measuring system is shown in FIG. 12B and is based on the use of a flow sensing blade 1244 which in one embodiment is attached to a front fixed blade 1240 via pivot 1242. In one embodiment the angle θ 1246 is measured via mechanical, electrical, or optical means and provides an indication as to the correction need to the yaw to align the platform with flowing fluid direction 300. In this embodiment when θ=approximately 180° the platform is approximately aligned with flowing fluid direction. In an alternate embodiment front fixed blade 1240 is not utilized. In yet another embodiment, the torque of the flow sensing blade 1244 on pivot 1242 is used to determine the flowing fluid direction 300.

In the embodiments shown in FIGS. 12A and 12B as well as in other embodiments where fluid flow direction 300 is measured, a control system including alignment motors and feedback are used to automatically align the system. As will be understood by one of skill in the art, by measuring the misalignment of the system, adjusting the yaw, and again measuring the direction of flow with respect to the orientation of the system, support plate assembly 10, and in particular horizontal platform axis 1180 can be made approximately parallel with fluid flow direction 300.

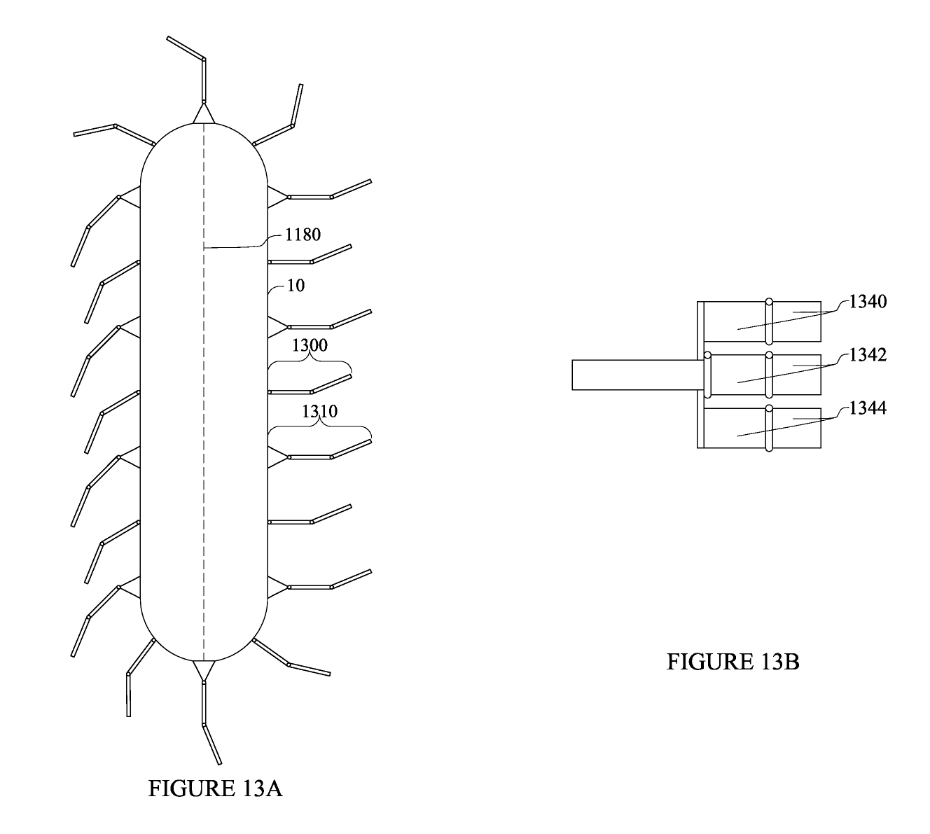

Referring to FIG. 13A a horizontally arrayed configuration is shown with inner blades 1300 and outer blades 1310. In this embodiment blades operating at different distances from horizontal platform axis 1180 are utilized to collect more power from the moving fluid. In this embodiment the blades are positioned such that the turbulence or shielding generated from inner blades 1300 is not so great that it prevents additional power from being extracted from outer blades 1310. As will be understood by one of skill in the art, the blades can be designed and arrayed such that additional power can be extracted over which would be extracted from a single set of blades.

FIG. 13B illustrates a vertically arrayed system in which center blades 1342 are used in conjunction with top blades 1340 and bottom blades 1344. This configuration provides for additional power extraction from the moving fluid. Other configurations of arrayed blades, including combinations of horizontal and vertical arrays of blades, can be used to extract additional power than what would be extracted using a single set of blades.

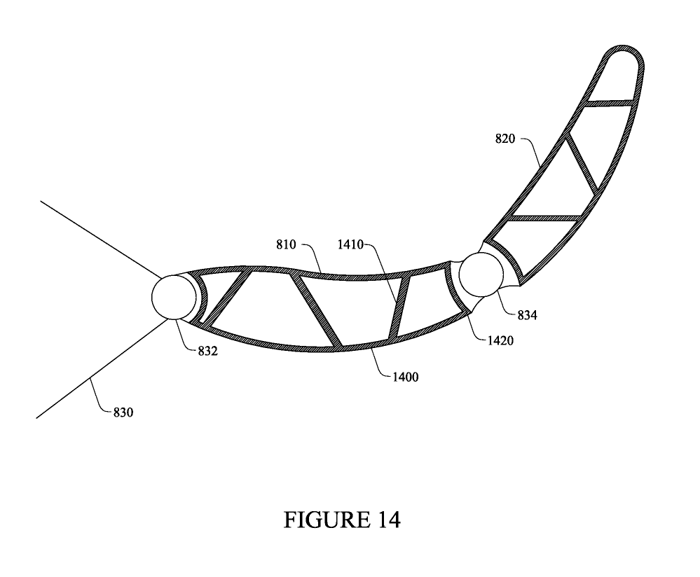

Referring to FIG. 14, a hollow blade is illustrated in which both outer blade 820 and inner blade 810 are completely or partially hollow and are created using a skin 1400 used in conjunction with supporting members 1410. In this embodiment the supporting members (typically of a lightweight composite material such as fiber-reinforced polymers, carbon-fiber reinforced plastic, carbon composite) provide structural strength while the skin 1400 (which can be a composite fabric, metal, plastic, Kevlar, or other suitable material) seals the blade clement. In the case of blades used in water, the configuration of FIG. 14 can be used to make the blade variable buoyancy by pumping in different gases or liquid. In one embodiment, air is pumped into the blade to cause it to float. In this embodiment combination of air and water can be used to make the blade water-density neutral, thus giving it approximately zero effective weight in the water. In other embodiments only one of outer blade 820 or inner blade 810 is made hollow, or compartments are used in the blade. In these embodiments by filling compartments or a single blade with air (or an alternate gas) the entire blade assembly can be made to be water-density neutral or to create buoyancy.

The advantages of the system and method are numerous. The strong, inherent, and renewable energy associated with flowing water is converted to electric energy by a simple submergible system. The system can be sized and configured for a variety of flowing water environments and a variety of electric energy generation applications. The system is environmentally friendly as it creates no sight pollution and its moving parts move no faster than the ambient flowing water thereby minimally impacting local flora and fauna.

Although the system has been described relative to several embodiments thereof, there are numerous variations and modifications that will be readily apparent to those skilled in the art in light of the above teachings. For example, the paddle/blade described herein could be realized by a multiple slat design (e.g., pivotable vertical slats, pivotable horizontal slats, two slats hinged along the axis of the paddle axle, etc.). In this embodiment, the slats would rotate to be perpendicular or parallel to the flowing fluid in the same way as the monolithic paddle/blades described earlier herein. If the pivots/hinges provide for this rotation in a passive fashion, the above-described paddle/blade flip control could be omitted.

Still another embodiment of the system includes the plate and multiple paddles, but not the rack and pinion gear system. In this embodiment, the gears would be replaced with an arm extending down to the plate from the axle/rod that supports the paddle/blade. The end of the arm would terminate in a permanent magnet riding within a groove in the plate. The sides and the bottom of the groove would incorporate conductor strips that alternate in polarity with insulation between them. As the permanent magnet is pushed forward through the groove with the alternating polarities, alternating electricity is generated by induction. The electricity can be tapped directly from each conductor with a wire or other suitable means, which are, in turn, then fastened to a conductive plate that gathers together all of the electricity generated at the individual conductors. This has the advantage of easily insulating the conductive plate and gathering all of the generated electricity. The amount of electricity produced is governed by the velocity of the magnet passing by a set of two conductors. Therefore, the conductors should be small and close together. This can be achieved by making a pre-insulated wire package that can be installed easily at the site. This embodiment could also make use of nano-conductors, which would enable realization of very high velocities due to the narrow width of two conductors.

The present system and method extracts power from a series of blades which are pushed by a moving fluid in what can be considered to be an endless path. The linear motion of the blades can be converted to rotational motion to drive a generator, or a linear configuration of magnets and coils can be used in a linear generator embodiment. In one embodiment the blades are caused to have a density close to that of water, thus reducing their effective weight and minimizing friction in the blade transport mechanism.

In an alternate embodiment magnetic levitation (maglev) technology is used (and can be used in conjunction with buoyant blades) to reduce or eliminate friction in the blade transport mechanism. In this embodiment permanent or electromagnets provide levitation and/or guidance for the blades in the blade transport mechanism. In one embodiment the maglev system is used in conjunction with linear generators, thus eliminating the need for a power train.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present disclosure is not limited to the particular examples and implementations disclosed herein, but is intended to cover modifications within the spirit and scope thereof as defined by the appended claims and any and all equivalents thereof.

What is claimed is:

1. A system for generating power from a moving fluid comprising:
a) a platform fixedly attached to the earth;
b) a blade transport mechanism supported by the platform;
c) a plurality of variable buoyancy blades operably coupled to the blade transport mechanism and oriented to couple energy from the moving fluid;
d) a power train operably coupled to the blade transport mechanism; and
e) a generator operably coupled to the power train for producing electric power.

2. The system of claim 1 wherein the platform comprises a top surface and a bottom surface connected by an edge portion, the edge portion having two opposing elongated sides connected by end portions, wherein the top surface and the bottom surface are generally parallel to the direction of flow of the moving fluid.

3. The system of claim 1, wherein the plurality of variable buoyancy blades are approximately density-neutral to water.

4. The system of claim 1, wherein the density of the plurality of variable buoyancy blades can be adjusted through the use of a gas.

5. The system of claim 4, wherein the gas is nitrogen or air.

6. The system of claim 1, wherein the blades can be configured for operation when the moving fluid changes direction.

7. The system of claim 1, wherein the blade transport mechanism is located on a top surface of the platform, the top surface being generally parallel to the direction of flow of the moving fluid.

8. The system of claim 1, wherein the plurality of variable density blades ride on a rail mechanism.

9. The system of claim 8, wherein the rail mechanism is located on a top surface of the platform that is generally parallel to the direction of flow of the moving fluid.

10. The system of claim 1, wherein the plurality of variable density blades ride in a slot mechanism.

11. The system of claim 1, wherein the blade transport mechanism comprises a belt mechanism, and wherein the power train comprises a set of gearing mechanisms for converting linear motion of the belt mechanism into rotational motion about an axis perpendicular to a plane formed by a top surface of the platform that is generally parallel to the direction of flow of the moving fluid.

12. The system of claim 1 wherein the blade transport mechanism comprises a belt mechanism, and wherein the power train comprises a set of gearing mechanisms for converting linear motion of the belt mechanism into rotational motion about an axis parallel to a plane formed by a top surface of the platform that is generally parallel to the direction of flow of the moving fluid.

13. A system for generating power from a moving fluid comprising:
a) a platform fixedly attached to the earth;
b) a blade transport mechanism supported by the platform;
c) plurality of blades which are substantially density neutral to the moving fluid, operably coupled to the blade transport mechanism and oriented to couple energy from the moving fluid;
d) a power train operably coupled to the blade transport mechanism; and
e) a generator operably coupled to the power train for producing electric power.

14. The system of claim 13 wherein the platform comprises a top surface and a bottom surface connected by an edge portion, the edge portion having two opposing elongated sides connected by end portions, wherein the top surface and the bottom surface are generally parallel to the direction of flow of the moving fluid.

15. The system of claim 13, wherein the plurality of blades are density neutral to water.

16. The system of claim 13, wherein the blade transport mechanism comprises a belt mechanism.

17. The system of claim 13, wherein the blade transport mechanism comprises a rail mechanism.

18. The system of claim 17, wherein the rail mechanism is located on a top surface of the platform.

19. The system of claim 13, wherein the blade transport mechanism comprises a belt mechanism, and wherein the power train comprises a set of gearing mechanisms for converting linear motion of the belt mechanism into rotational motion about an axis perpendicular to a plane formed by a top surface of the platform that is generally parallel to the direction of flow of the moving fluid.

20. The system of claim 13, wherein the blade transport mechanism comprises a belt mechanism, and wherein the power train comprises a set of gearing mechanisms for converting linear motion of the belt mechanism into rotational motion about an axis parallel to a plane formed by a top surface of the platform that is generally parallel to the direction of flow of the moving fluid.

21. A system for generating power from moving fluid comprising:
a) a platform fixedly attached to the earth;
b) a blade transport mechanism supported by the platform;
c) a plurality of arrayed blades operably coupled to the blade transport mechanism and oriented to couple energy from the moving fluid;
d) a power train operably coupled to the blade transport mechanism; and
e) a generator operably coupled to the power train for producing electric power.

22. The system of claim 21 wherein each of the plurality of arrayed blades comprises a first blade hingedly connected to a second blade.

23. The system of claim 22 wherein the first and second blades form a vertically stacked array.

24. The system of claim 22 wherein the first and second blades form a horizontal array.

25. The system of claim 21 wherein each of the plurality of arrayed blades has a variable buoyancy.

26. The system of claim 21 wherein each of the plurality of arrayed blades is approximately density-neutral to water.

27. A system for generating power from moving fluid comprising:
a) a platform fixedly attached to the earth;
c) a plurality of blades mounted to the platform via a maglev subsystem and oriented to couple energy from the moving fluid;
d) a power train operably coupled to the array of blades; and
e) a generator operably coupled to the power train for producing electric power.

28. The system of claim 27, wherein the generator is part of the maglev subsystem.

29. The system of claim 27, wherein the blades are variable buoyancy.

30. The system of claim 27, wherein the blades are approximately density-neutral to water.

31. The system of claim 27, wherein buoyancy of the blades can be adjusted through the use of a gas.

32. A system for generating power from moving fluid comprising
a) an adjustable platform fixedly attached to the earth;
b) a plurality of blades operably coupled to a power train located in the adjustable platform and oriented to couple energy from moving fluid; and
c) a generator operably coupled to the power train for producing electric power.

33. The system of claim 32, wherein the adjustable platform comprises a top surface and a bottom surface connected by an edge portion, the edge portion having two opposing elongated sides connected by end portions, with the top surface and bottom surface being generally parallel to the direction of flow of the moving fluid and

34. The system of claim 32, wherein the adjustable platform is variable buoyancy.

35. The system of claim 34, wherein the adjustable platform can be raised to the surface by increasing buoyancy of the adjustable platform.

36. The system of claim 32, further comprising:
d) a directional adjustment subsystem.

37. The system of claim 36, wherein the directional adjustment subsystem contains at least one bridle and windlass.

38. The system of claim 36, wherein the directional adjustment subsystem contains a flow direction sensor.

39. The system of claim 38, wherein the directional adjustment subsystem comprises a flow direction rudder.

40. The system of claim 36, wherein the directional adjustment system comprises a control system which automatically senses flow direction and changes direction.
